(19) United States
(12) Patent Application Publication
(10) Pub. No.: US 2002/0130867 A1
(43) Pub. Date: Sep. 19, 2002

(54) Method of constructing progressive mesh

(76) Inventors: Kai-Shu Yang, Tainan (TW); Chin-Chen Chang, Hsinchu (TW); Ding-Zhou Duan, Kaohsiung (TW); Ming-Fen Lin, Hsinchu (TW)

Correspondence Address: J.C. Patents, Inc., Suite 250, 4 Venture, Irvine, CA, 92618, US

(21) Appl. No.: 09/920,035

(22) Filed: Aug. 1, 2001

(30) Foreign Application Priority Data
Mar. 14, 2001 (TW) 90105912

(51) Int. Cl. G06T 17/00

(52) U.S. Cl. 345/428

(57) ABSTRACT

A method of constructing a progressive mesh using a forest clustering algorithm and all types of error evaluation, for maintaining a quality with a height similar to an original mesh. The method is capable of reducing any number of vertices or triangles in a single step so as to produce a progressive mesh that enables a smooth and fast change of the resolution. The mesh is applicable to both network transmission and real-time rendering.

### CROSS-REFERENCE TO RELATED APPLICATION

This application claims the priority benefit of Taiwan application serial no. 90105912, filed Mar. 14, 2001.

### BACKGROUND OF THE INVENTION

1. Field of Invention

The present invention relates to a method of constructing progressive mesh. More particularly, the present invention relates to a method of constructing progressive meshing operation using a forest-clustering algorithm.

2. Description of Related Art

The appearance of virtual reality software in the market has recently created a demand for high-quality pictures. Although hardware products have been advanced at a tremendous pace, actual picture quality can barely keep up with the user's demand for picture quality. Hence, software designers widely employ a technique known as levels of detail. In the picture field, objects further away from the viewer are meshed using a rough mesh so that the loading on the rendering hardware is lowered without affecting the actual quality of output picture. In other words, the technique is capable of reproducing rather complicated scenes with the same hardware rendering ability. FIGS. 1A-1C are perspective views of a street light meshed using different resolutions. As shown in FIGS. 1A-1C, if instead of using resolution (a) to render the street light at different distances, resolution (b) is used when the viewer is at a moderate distance while resolution (c) is used when the viewer is farther away, the rendering hardware would have a significant loading, even though such rendering method would have little effect on picture quality.

At present, the commonly adopted scheme is to prepare a number of meshes of different resolutions for each object in the picture field. When the picture is rendered, a mesh is selected according to the distance between the object and the viewer. However, this type of operation often uses a lot of memory space. Moreover, there is yet another problem. Objects moving from far to near relative to the viewer (or near to far) will appear to be coarser rather than finer for a while if the number of meshes of different resolution prepared for each object is too few. In other words, the objects will appear to be stolen from the picture field and then put back creating an awkward visual effect. Ideally, the resolution change of the objects should be made undetectable to the viewer when the viewing distance from the object is changed.

To fulfill such requirement, a progressive meshing technique is developed. Progressive meshing uses a multi-resolution type of meshing format. The concept of this technique is to save the intermediate data during a mesh simplification process as well as the simplified mesh after the mesh simplification process. Ultimately, the data in the progressive mesh needs to enable a smooth change of resolution, a control of mesh resolution, and a resolution adjustment to the mesh in time when the mesh is sketched.

The so-called “resolution” usually refers to number of vertices or faces on the mesh, with a smaller number producing a more rough visual effect. For example, a mesh with 500 faces and a mesh with 1000 faces are meshes with two different resolution levels. And a difference in resolution levels of the two meshes is known as an error between the two levels.

The following is a description of the two major constructs of progressive meshing operation.

1. Vertex clustering: FIG. 2 is a sketch showing the processing in vertex clustering. As shown in FIG. 2, space occupied by the mesh is divided into a number of miniature cells. A representative vertex is determined in each cell according to its visual importance in the mesh. All the other non-representative vertices in the cell are merged to the representative vertex. For each triangle in the mesh, after the combination of vertices, all the triangles having two or more vertices combined with the same vertex are removed. Consequently, the vertex clustering method is capable of removing a large number of vertices and triangles in a single operation. However, the method does not specifically retain additional geometric data in characteristic parts of the mesh. Hence, shape preservation of the mesh is poor.

2. Edge collapsing: The method relies on removing edges that has the least effect on the shape of the mesh. FIG. 3 is a sketch showing the processing in edge collapsing. As shown in FIG. 3, the two end-points (νₜ, νₛ) are combined to form a single vertex ν_{s′} so that the triangles on each side of the original edge (νₜ, νₛ) are removed. This method of combining vertices and removing edges is referred to as edge collapsing. In an edge-collapsing step, two triangles are deleted. Since edge collapsing is a reversible process, the vertex ν_{s′} can be split into vertices νₜ and νₛ, then reinserted the two triangles (νₜ, νₗ, νₛ) and (νᵣ, νₜ, νₛ) back again when mesh refining is required. Such an operation is also called vertex splitting.

Hence, the edge collapsing method is capable of reducing a complicated mesh into a simpler mesh in a series of edge collapsing steps and reproducing the complicated mesh from the simpler mesh by reversing the series of edge collapsing steps. This is the concept behind the original progressive meshing technique developed by Microsoft Research in 1996.

FIG. 4 is a schematic diagram showing the steps in progressive meshing. As shown in FIG. 4, a progressive meshing mesh M is used to illustrate the series of edge collapsing steps. Assume the crudest state is represented by M⁰. After a vertex splitting (refining) operation R₁, the mesh is converted to another state M¹. The mesh can be reverted from state M¹ to state M⁰ by reversing the operation R₁ (a coarsening operation), in other words, executing a crude C₁ operation. By the same argument, a mesh in the state Mⁱ can be refined to a state Mⁱ⁺¹ by performing a refining operation Rᵢ₊₁. Conversely, a mesh already in the state M¹⁺¹ can be reverted back to a state Mⁱ by performing a coarsening operation Cᵢ₊₁. Therefore, a progressing meshing mesh M with n refining operations R has n+1 different states or n+1 levels of resolution.

As shown in FIG. 3, each edge-collapsing step is able to remove two triangles from the mesh. Hence, a progressive meshing method employing the edge-collapsing algorithm can remove at most two triangles from the mesh mesh at a time. Although edge-collapsing algorithm has fine meshing power and can retain characteristics of the original mesh, removing or increasing two triangles at a time is too slow. For example, the mesh in FIG. 1A is composed from 8828 triangles. To simplify the mesh shown in FIG. 1A to the one shown in FIG. 1C with 500 triangles, at least (8828-500)/2=4164 edge-collapsing steps have to be carried out. Consequently, the method is unsuitable for real time rendering or image transformation requiring rapid vertex and triangle deletion.

Due to the rapid development of network and the expansion of electronic business, progressive meshing techniques are now highly valued. By transmitting a mesh through a network, products that used to be displayed in two-dimensional form can now be explained or illustrated three-dimensionally. Businessman may now download the mesh and associated data of a particular product from the net and watch the illustration or even operate the product in real time.

However, object meshing needs to handle a volume of data much higher than ordinary video processing. Moreover, a multiple of resolutions of the mesh has to be prepared by progressive meshing so that a user may receive a coarse outline of the product and carry on with other operations without much waiting. The mesh may be fine-tuned later when more data are received. In this way, the server may respond faster while the user may wait less. Moreover, unwanted transmission can be terminated by the user before the end of the data transmission saving much transmission loading. Hence, progressive meshing is of great benefit to those users required to browse through a large number of meshes in a short time.

### SUMMARY OF THE INVENTION

In general, the two aforementioned methods have some insurmountable drawbacks when applied to progressive meshing.

Accordingly, one object of the present invention provides a method of constructing the progressive meshing using a forest-clustering algorithm, which utilizes quality control methods and error estimation schemes to reproduce a highly similar simplified mesh or a progressive mesh of the original mesh. The method also satisfies the need for a real time rendering and network transmission.

To achieve these and other advantages and in accordance with the purpose of the invention, as embodied and broadly described herein, the invention provides a method of constructing progressing meshes using a forest-clustering algorithm. The method includes the following steps. In step (a), a cluster is constructed for each vertex in a single resolution mesh constituted of a plurality of vertices. An expansion is constructed by connecting the vertex with its adjacent vertices, while the cost of an expansion operation is calculated. Next, in step (b), the expansion operation with the lowest cost is applied to construct a forest repeatedly. The most effective expansion operation (i, j, k) with the lowest cost is performed, with i, j, k as vertices in the mesh, vertex k as a root of the cluster after the connection until the first termination condition is fulfilled. Then, in step (c), a clustering simplification is performed to each cluster c(t) in the forest above, combining non-root vertices, wherein t is the representative vertex of the cluster c(t).

Step (b) and (c) are repeated until the second termination condition is fulfilled, so as to produce a simplified mesh defined by the user.

In step (c), each simplification operation is recorded as a simplification log, so that the simplification log can be converted to a revert sequence to be applied for mesh refinement in the future.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A˜1C are perspective views of a street light meshed using different resolutions;

FIG. 2 is a sketch showing the processing in vertex clustering;

FIG. 3 is a sketch showing the processing in edge collapsing;

FIG. 4 is a schematic diagram showing the edge collapsing steps in progressive meshing;

FIG. 5 is a diagram showing a mesh of a Beethoven head sculpture represented by 5030 triangles into a simplified mesh by eliminating 2012 triangles in a single forest-clustering progressive meshing operation;

FIG. 6 shows a vertex cluster c(u), c(ν₀) and expansion e=(u, ν, ν₀); and

FIG. 7 shows a forest clustering operation of the cluster shown in FIG. 6.

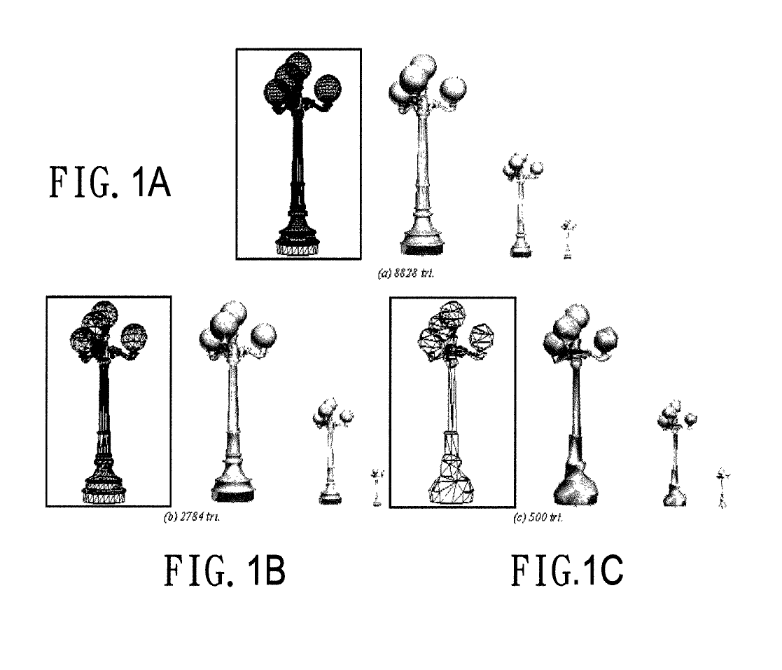

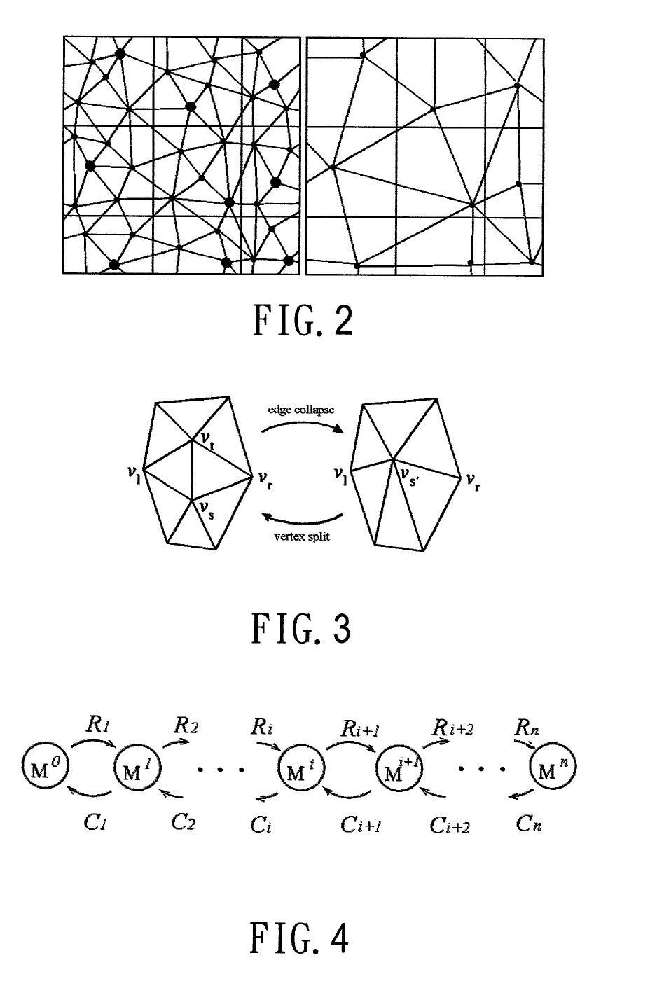

The file of this patent contains at least one drawing executed in color. Copies of this patent with color drawing(s) will be provided by the Patent and Trademark Office upon request and payment of the necessary fee.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In general, the two aforementioned methods have some insurmountable drawbacks when applied to progressive meshing.

Since the vertex clustering is unable to detect any surface variation of the mesh, the characteristics of the mesh are retained. So, spatially close vertices are combined. Although edge-collapsing method actually performs a cost estimation before combining two vertexes and hence able to retain mesh characteristics, the algorithm is too slow. Unlike forest clustering technique, edge-collapsing technique cannot eliminate large amount of geometric data in a single operation.

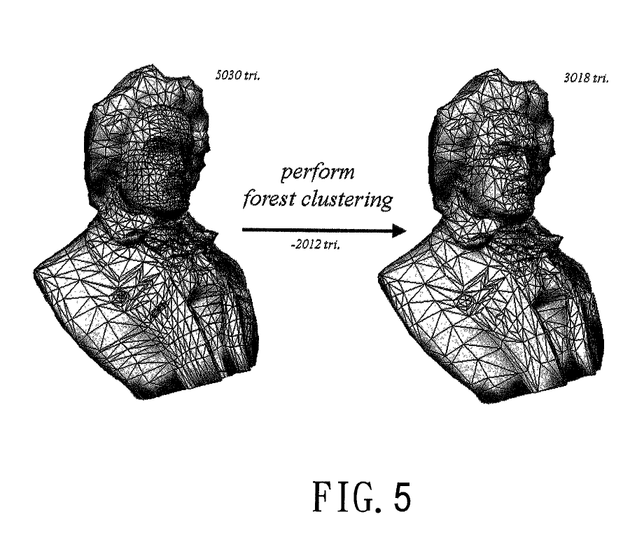

To eliminate the drawbacks of the conventional techniques, this invention uses a method of constructing a progressive mesh using a forest-clustering algorithm. The cost of combining vertices is actually estimated and the combination range is found as a forest of edges over the mesh. Hence, forest-clustering technique is able to combine the advantages of vertex clustering and edge collapsing. FIG. 5 is a diagram showing the simplification of a Beethoven head sculpture represented by 5030 triangles into a simplified mesh by eliminating 2012 triangles in a single forest-clustering progressive meshing operation.

(1) Cost evaluation of an expansion: constructing a cluster for each vertex in an input mesh with single level of resolution, constructing an expansion from each vertex to its adjacent vertices, and conducting a cost evaluation of the combination so as to deduce the cost of expansion operation for combining several vertices to a vertex.

(2) Forest growth: repeating the expansion operation (u, v, v₀) with the lowest cost to grow the forest until the termination condition of that round is fulfilled. In the expansion operation, the combining vertex v₀ is the representative vertex. In other word, the vertex is a root of a vertex tree.

(3) Performing clustering simplification: for each tree in the forest growth, the non-root vertices are combined to the root vertices. Then, a further morphing operation is conducted to the triangles with one vertex that is combined, wherein the triangles with the combined vertex are replaced as representative vertices of the cluster. The triangles with more than two vertices combining to the same vertex are eliminated from the mesh. In the meantime, the simplification operation that has been conducted is memorized.

Step (2) and (3) are repeated until the termination condition defined by the user is fulfilled, so as to produce a simplified mesh required by the user. And the memorized simplification operation can be converted to a refinement sequence.

The mesh is constructed from a plurality of points (vertices) associated into a plurality of triangles. Here, a vertex cluster is chosen as a subset of the mesh vertices. The vertex cluster includes a representative vertex and other vertices within the cluster are ultimately combined with the representative vertex to complete a mesh simplification. The vertex cluster is not only a subset of the mesh vertexes, but is also a vertex tree of the mesh topography. The representative vertex in the cluster is the root.

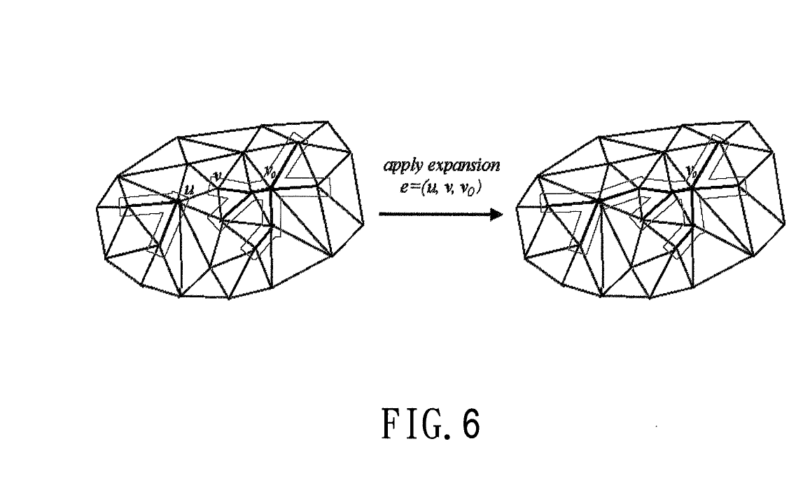

Here, c(x) is used to represent a vertex cluster with a representative point x. FIG. 6 shows a vertex cluster c(u), c(ν₀) and expansion e=(u, ν, ν₀). As shown in FIG. 6, c(u) and c(ν₀) use points u and ν₀ as representative points respectively. The expansion e=(u, ν, ν₀) is arrived at by performing a computation to combine c(u) with c(ν₀) via the connective edge line (u, ν). The cost of e is the largest value among the cost estimations for combining the vertices in the vertex cluster c(u) with the representative point ν₀. And the so-called applying expansion e is conducted by connecting up lines (u, v). Next, for each vertices adjacent ot the vertex in the mesh, a cost for each vertex to combine each adjacent vertex is calculated, so as to conduct a cost evaluation of the expansion operation.

When the cost of combining two vertices is evaluated, there are different defining methods. For example, one method may choose the shortest edge of the mesh for edge collapsing, with the moving distance combining the endpoint vertices as a cost until the all length of edges of the mesh are larger than the pre-determined tolerance value. Another method may choose the edge with two vertices most adjacent to a conformal plane for edge collapsing, with a sum of a squared vertical distance for combining the vertices away from the plane of the triangle and a rotational angle of the normal vector of adjacent faces after combining the vertices near to the plane of the triangle as the cost.

There are also methods that does not provide the tolerance value at all. The edge collapsing operation is repeated until the number of triangles is reduced down to the value determined by the user. Also, a method of defining the cost with a rectangular format is proposed, where a vertex v with an error as “a sum of a squared vertical distance for edge collapsing the endpoint vertices away from the plane of the triangle” is defined. And the sum of error produced when combining two vertices in one edge line is the cost for collapsing this edge line.

In the meantime, the users have set the following conditions according to their goal of simplifying the progressive mesh, so as to construct the progressive mesh that fulfills the user's need:

1. The step condition between levels, for deducing a terminating condition for each round of forest growth. For example, during the simplification operation, each simplification level increases the number of the triangles by 10% of the previous level, or the error is reduced to 90% of the previous level. The system then deduces according to the step condition “the termination condition for each round of simplification” (first termination condition), such as the number of triangles set to be reduced in this round or the upper limit of error in this round.

2. The critical condition for the base mesh, as “termination condition of mesh simplification” (second termination condition), such as the number of triangles less than a set number, an upper limit of errors of the simplified mesh and original mesh, or a certain number of resolution levels.

Next, a forest growth step is conducted. An expansion operation is conducted for connecting an edge of the mesh, with the system continuously conducting the expansion operation until the termination condition (first termination condition) is fulfilled in each round. The edges are connected up to form a forest. To all the trees in such forest, a root vertex is known as a representative vertex of the trees.

In this invention, ‘survival of the fittest’ strategies are employed so that vertex combinations requiring a higher cost are retained as representative vertices. By doing this, a combination standard value is set. When the cost estimation value of the combination is lower than the combination standard value, a linear expansion of the two neighboring vertices is carried out to form a trunk. After the combination, the vertex having the higher estimated combination cost is retained to become a root. The clustering algorithm also provides a priority queue for the computed expansions. When expansions are stored from small to large according to their cost, the initial state is empty. A cluster c(x) is constructed around each vertex x in the mesh. Besides x, there are no other vertices in the cluster c(x). Relative to x, expansion (y, x, x) is constructed around each neighboring points y. After a cost estimation of the expansion, the estimates are stored inside the queue. Obviously, the queue also stores (x, y, y). In generating the forest, if the cost of (y, x, x) is higher than the cost of (x, y, y), expansion (x, y, y) is executed while expansion (y, x, x) is discarded.

In operation, the ones with the lowest cost are repeatedly taken out from the queue of expansion. If the first termination condition does not hold (meaning that the number of triangles has not reached beyond the error tolerance range), the forest growth is continued. As shown in FIG. 6, if the retrieved expansion is (u, ν, ν₀), the vertex c(u) is connected to point ν of c(ν₀) so that c(u) becomes the sub-tree of c(ν₀). At this stage, the cluster c(u) is combined into c(ν₀ ) and hence no longer exists. Consequently, all the expansions (u, *, *) requiring to combine with c(u) must be discarded. The cluster c(u) requiring to combine with the expansions (*, *, u) of other clusters is rewritten as a combination with expansion (*, *, ν₀) through c(ν₀), wherein * represents any vertex. The expansion (u, v, v₀) is discarded as follows: when the vertex u is combined to certain cluster c(x) or the operation of expansion (v, u, x) has been conducted, the expansion (u, v, v₀) is discarded (become disabled). If the cluster c(v₀) has ever combined with other vertices after the expansion (u, v, v₀) is constructed, it would be returned to the memorized column after the cost of the expansion operation is re-calculated. But if the vertex v₀ is merged to the cluster c(w), then the expansion (u, v, v₀) is changed to (u, v, w), and the expansion would be returned to the memorized column after the cost of the expansion operation is re-calculated, wherein x, w represent any vertices that differ from the vertex v₀.

Through repeated combination of cluster to generate a forest and counting the number of eliminated triangles at the same time or gathering data regarding the errors after combination, whether to terminate the current round of forest expansion is determined. Hence, the progressing mesh constructed according to the present invention is capable of monitoring the geometric data or errors in each layer of resolution.

The clustering operation is conducted for each tree grown in the forest, where the non-root vertices in the tree are merged to the root vertex so as to reduce the number of the vertices, i.e. the sum of the non-root vertices in each tree. However, if there is only one vertex to be combined in the triangle, the vertex to be combined is replaced by a representative vertex, while the triangle would not be eliminated. If there are two and more vertices to be combined in the triangle, and the vertices are not combined to the same vertex, the vertices to be combined are replaced with representative vertices. But when there are at least two vertices to be combined to the same vertex in the triangle, the triangle would be eliminated since it has been collapsed.

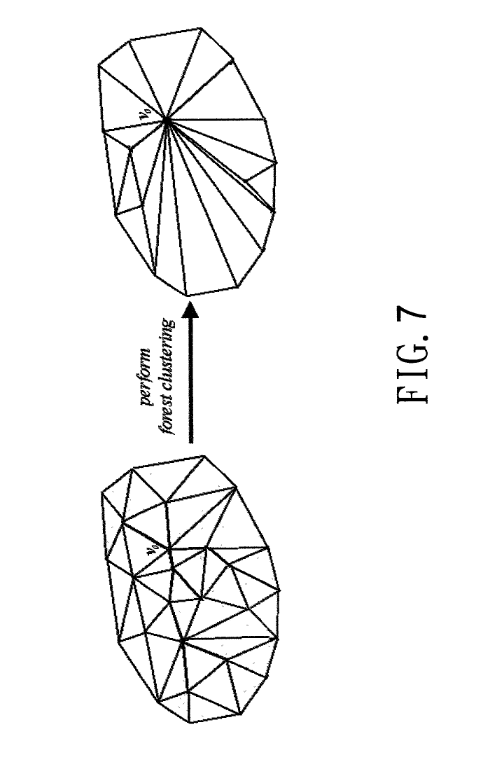

FIG. 7 shows a forest clustering operation of the cluster shown in FIG. 6. As mentioned before, each cluster is a vertex tree. Three things need to be executed to cluster around c(ν₀):

1. The vertices on the trunk of the root expansion must combine with the root (that means, each vertex outside vertex ν₀ on the tree must be merged to ν₀).

2. The triangles having a trunk passing through more than two vertexes are removed (that means, triangles that use more than two vertices in the cluster c(ν₀) are removed).

3. The corner of a triangle with a trunk passing through a vertex is moved to the root to form a simplified mesh (that means, in operation, with regard to a triangle using the vertex of a c(ν₀) but not ν₀, the vertex corner is moved to the position ν₀).

Since each vertex tree in the forest undergoes such treatment, each cluster will return to a state having just one representative point. Hence, the next round of mesh simplification can be executed and repeated until the base mesh is obtained. During each round, the removed vertices, triangles and corners of triangles are memorized as a simplification record.

A simplification round comprises of two steps such as forest growth and clustering. And after each round, it is checked to see if the mesh simplification termination condition is fulfilled. If the condition were not fulfilled, it would proceed to the next round of simplification. That is, to repeat the steps with the same base mesh described above, until the base mesh that meets one user's need is formed. In the meantime, the simplification record that is memorized above is converted into a series of refinement sequence and saved together with the simplified mesh.

Based on the coarsest mesh and according to the memorized simplification record of removing vertices and triangles and the record of moving some corners of the triangles, a reverse operation can be applied to the simplified mesh. Hence, all the vertexes and triangles can be reconstituted to the original state so that finer details of the mesh can be revealed. Thus, by storing up all the steps in simplifying a mesh, a highly efficient resolution of transformable progressing meshing technique is obtained.

In application, such as indicated in documents for supporting the 3D mesh object specification of MPEG-4, this type of clustering type will generate an algorithm in removing triangle strips. Therefore, a progressive mesh that meets the MPEG-4 standard specification will be generated. This invention provides an algorithm, as long as a topographic testing according to MPEG-4 is applied to the generated forest, which is capable of preventing the non-manifold curvature produced due to the vertex combination. Hence, the production of internal vertex inside the deleted triangle area. Ultimately, each round of triangle removal can be integrated with several triangular sections and stored in MPEG-4 standard format using a progressive split-compression technique.

In summary, major characteristics and advantages of the progressive mesh in this invention includes:

1. The original geometric properties and attributes of the mesh are preserved.

2. The data and errors in each layer of resolution are retained so that different levels of detail can be brought out smoothly.

3. Refining or coarsening the mesh can be achieved in real time.

In a distributed virtual environment, the mesh can be transmitted to a customer through a data network and execute all kinds of resolution processing. Hence, the invention can cater for real-time networking transmission. The progressive meshing technique in the invention is particularly beneficial in electronic business because user may have to browse through a large number of 3-D meshes in short period. The technique is also advantageous for producing and transmitting game scenes through the network so that more complicated and appealing visual scenes can be created without additional hardware. In addition, in a simulated platform such as a CAVE system, real-time rendering of several picture screens must be conducted so that hardware loading is particularly heavy. The invention provides a technique that is capable of lowering the unnecessary loading for the hardware. This enables rendering of a more complex field view, presenting a more refined picture.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of constructing a progressive mesh, the method comprising the steps of:
(a) constructing a cluster from each vertex in a single resolution mesh constituted of a plurality of vertices, constructing an expansion operation by connecting the vertex with its adjacent vertices, and calculating a cost of the expansion operation;
(b) repeating the expansion operation with the lowest cost for constructing a forest, wherein the expansion operation (i, j, k) with the lowest cost is performed, with i, j, k as vertices in the mesh, vertex k as a root of the cluster after the connection until the first termination condition is fulfilled;
(c) performing a clustering simplification to each cluster c(t) in the forest above, merging non-root vertices to t, wherein t is a representative vertex of the cluster c(t); and
(d) repeating step (b) and (c) until the second termination condition is fulfilled, so as to produce a simplified mesh.

2. The method of claim 1, wherein the step of constructing the forest further comprising steps of:
obtaining an expansion (u, v, v₀) with the lowest cost, wherein u, v, v₀ are vertices in a single resolution mesh
setting the expansion (u, v, v₀) as disabled if the vertex u has combined with a cluster c(x) or an expansion (v, u, x) has been carried out, wherein x is any vertex that differ from the vertex v₀ in the single resolution mesh.

3. The method of claim 2, wherein the step of constructing the forest further comprising a step of:
recalculating the cost of expansion operation without carrying out the expansion operation if the cluster c(v₀) is combined with other vertices after the expansion (u, v, v₀) is constructed.

4. The method of claim 2, wherein the step of constructing the forest further comprising a step of:
converting the expansion (u, v, v₀) into (u, v, w) and recalculating the cost of expansion operation without carrying out the expansion operation (u, v, v,) if the vertex v₀ is merged to a cluster c(w), wherein w is any vertex that differs from vertex v₀ in the single resolution mesh.

5. The method of claim 3, wherein the step of constructing the forest further comprising a step of:
converting the expansion (u, v, v₀) into (u, v, w) and recalculating the cost of expansion operation without carrying out the expansion operation (u, v, v₀) if the vertex v₀ is merged to a cluster c(w), wherein w is any vertex that differs from vertex v₀ in the single resolution mesh.

6. The method of claim 2, wherein the representative vertex t is combined with each vertices outside the representative vertex t when the clustering simplifiaction is performed.

7. The method of claim 6, wherein a plurality of vertices for constituting a resolution mesh forms a plurality of triangles, and the step of performing the clustering simplification further comprising a step of eliminating those triangles using two or more vertices in the cluster c(t).

8. The method of claim 6, wherein a plurality of vertices for constituting a resolution mesh forms a plurality of triangles, and the step of performing the clustering simplification further comprising a step of moving the corner of the triangle which uses a non-representative vertex t in the cluster to where the representative vertex is located.

9. The method of claim 7, wherein the step of performing the clustering simplification further comprising a step of moving the corner of the triangle which uses a non-representative vertex in the cluster c(t) to where the representative vertex is located.

10. The method of claim 5, wherein the step of performing the clustering simplification further comprising a step of merging each vertices outside the representative vertex t to t.

11. The method of claim 10, wherein the plurality of vertices for constituting the resolution mesh forms a plurality of triangles, and the step of performing the clustering simplification further comprising steps of:
eliminating those triangles that use two or more vertices in the cluster c(t); and
moving the corner of the triangle which uses a non-representative vertex in the cluster c(t) to where the representative vertex is located.

12. The method of claim 1, wherein the clustering simplification further comprising a step of saving each round of simplification as a simplification record.

13. The method of claim 12, further comprising a step of converting the simplification record into a refinement sequence.

14. The method of claim 9, wherein the clustering simplification step further comprising a step of saving each round of simplification as a simplification record.

15. The method of claim 14, further comprising a step of converting the simplification record into a refinement sequence.

16. The method of claim 11, wherein the clustering simplification step further comprising a step of saving each round of simplification as a simplification record.

17. The method of claim 16, further comprising a step of converting the simplification record into a refinement sequence.

18. The method of claim 1, wherein the first termination condition is deduced from a step condition between levels in an user-defined resolution mesh.

19. The method of claim 1, wherein the second termination condition is the coarsest mesh condition defined by an user.

20. The method of claim 19, wherein the second termination condition is the coarsest mesh condition defined by an user.

21. The method of claim 13, wherein the first termination condition is deduced from the a step condition between levels in an user-defined resolution mesh and the second termination condition is the coarsest mesh condition defined by an user.

22. The method of claim 15, wherein the first termination condition is deduced from the a step condition between levels in an user-defined resolution mesh and the second termination condition is the coarsest mesh condition defined by an user.

23. The method of claim 17, wherein the first termination condition is deduced from the a step condition between levels in an user-defined resolution mesh and the second termination condition is the coarsest mesh condition defined by an user.
